(19) United States
(12) Patent Application Publication
(10) Pub. No.: US 2010/0134641 A1
(43) Pub. Date: Jun. 3, 2010

(54) IMAGE CAPTURING DEVICE FOR HIGH-RESOLUTION IMAGES AND EXTENDED FIELD-OF-VIEW IMAGES

(75) Inventors: Stefan Marti, San Francisco, CA (US); Paul Fahn, Sunnyvale, CA (US)

Correspondence Address: Beyer Law Group LLP, P.O. BOX 1687, Cupertino, CA, 95015-1687, US

(73) Assignee: Samsung Electronics Co., Ltd., Suwon City (KR)

(21) Appl. No.: 12/325,742

(22) Filed: Dec. 1, 2008

(51) Int. Cl. H04N 5/225; G06K 9/32

(52) U.S. Cl. 348/222.1; 382/299; 382/298; 348/E05.024

(57) ABSTRACT

An image capturing device, such as a digital camera, is able to take photos having a resolution higher than the native resolution capabilities of the device determined by the imager. The device can also take photos having a field-of-view (FOV) that is greater than the normal capabilities of the device. The photos taken have a higher vertical and horizontal FOV (or only an increased horizontal FOV creating a panoramic photo) than the lens of the imager allows natively. The imager of the device may be positioned to point in different directions using an actuator, that is, the actuator can pan and tilt the imager. The imager can also zoom in or out at various levels and has a maximum zoom level. To create either type of photo, an array of cells is used as a tool to capture a series of subimages where the imager is pointed in different directions for each subimage. To create the high-resolution photo, the imager is zoomed into its maximum level and captures each of the subimages based on the array of cells. To create the extended FOV photo, the imager is panned and tilted as much as possible using the actuator and captures each of the subimages based on the array of cells. In both cases the subimages are then stitched together to form a final image.

### BACKGROUND OF THE INVENTION

1. Field of the Invention

The present invention relates to digital photographic equipment and software. More specifically, it relates to high resolution imaging, extended field imaging, and image stitching.

2. Description of the Related Art

With the advent of digital photography, consumers, many of whom are not professional photographers, have been able to take many more photographs using digital cameras, store them in convenient formats for displaying and sharing, and perform enhancements on them with relatively simple software programs. Most of the alterations and enhancements are done after the photograph is taken with software tools that have become widely available to consumers. The digital cameras themselves, with the exception of very high-end cameras, have not fundamentally changed. Resolutions have improved and the number of options with respect to lighting, for example, has increased.

However, the way pictures are taken has not changed over the years. A digital camera cannot take pictures with a resolution higher than the maximum native resolution based on the hardware limits of the camera's lens subsystem and image sensor, except by using additional external computing resources such as dedicated software on a personal computer. Also, a digital camera having a certain maximum field of view cannot take pictures that encompass a greater field of view; the maximum FOV is a physical characteristic or embodiment of the camera lens subsystem that cannot be modified. Photo enhancing software, for example, cannot increase the FOV of the image captured by a digital camera, nor can it typically increase the resolution of a picture. Other enhancements may increase the clarity or color of a picture, but the underlying resolution stays the same.

Presently, there are mechanical devices and peripherals that can be added to a digital camera which allow creation of images whose resolution or field of view exceed the native capacity of the camera. These include actuated lens holders which are attached to cameras to enable movement of the imager or lens of the camera. These often also require a tripod, mount, or other mechanical attachment, such as controlled imagers or actuation mechanisms, which many lay consumers do not want to use or know how to use. This may be because of the risk involved in damaging the camera when attaching and using such equipment, the inconvenience of having to carry large or heavy equipment, and high equipment costs. Consumers taking casual or recreational photos with digital cameras most often want compactness, ease of use (including durability), versatility, and economy (of the cost of the camera and with photo development and storage). Current methods of increasing a camera's resolution or field of view are not in line with these consumer-driven digital camera attributes.

### SUMMARY OF THE INVENTION

One embodiment is a method of creating a high-resolution digital image using an image capturing device, such as a digital camera. The user of the device frames a preview image in a preview display (viewfinder display) of the device. The relevant system within the device obtains the preview image which has an original resolution. It also obtains the optical zoom level (focal length) used to create the preview image. The system uses this zoom level and the maximum zoom level of the device to calculate a subimage number. In one embodiment, the subimage number is derived from an array of cells, each cell corresponding to a subimage. The array has a horizontal number of cells and vertical number of cells. The subimage number is the product of these two numbers. The imager of the device captures a subimage number of subimages, that is, the device takes a certain number (a subimage number) of pictures of different segments of the preview image. The image zooms into a maximum or higher zoom level before capturing each of the subimages. Each of the higher resolution subimages are stitched or combined together to create a high-resolution final image.

Another embodiment is a method of taking a digital image having an extended field-of-view (FOV), that is, covering a wide horizontal and vertical span. A preview image is framed by the user in the preview display of an image capture device, such as a camera. The preview image is one segment of a larger final image but only the preview image can be seen in the preview (or viewfinder) display. The preview image has an initial FOV creating a top and bottom border and a left and right border. The top and bottom borders define a vertical component of the initial FOV and the left and right borders define a horizontal component of the FOV (sometimes referred to as the panoramic view). The system obtains the preview image and an initial (or current) zoom level and its corresponding FOV, for example, by using a zoom level-FOV data table. The FOV may have a vertical component and a horizontal component. These data are used to calculate a subimage number, which may be the product of a horizontal number of cells and a vertical number of cells from an array of cells. The imager of the device captures a subimage number of subimages, as described in the high-resolution embodiment, thereby creating an array of subimages. The number of cells in the array may depend on the tilting and panning capabilities of an actuator mechanism that moves the imager. The subimages captured are of the scenes or areas surrounding the preview image. The subimages are stitched or combined to form a final extended FOV image which covers more area than the preview image. In one embodiment, the resolution of the preview image and the final image is the same. The two images differ in the amount of area or space captured in each image.

### BRIEF DESCRIPTION OF THE DRAWINGS

References are made to the accompanying drawings, which form a part of the description and in which are shown, by way of illustration, particular embodiments:

FIG. 1 is an illustration of an initial photo also referred to as image capture, using a digital camera;

FIG. 2 is an illustration of digital camera showing preview display in accordance with one embodiment;

FIGS. 3A and 3B are block diagrams showing two images displayed in preview display during the process of taking a high-resolution photo of a scene and also shows a front view of camera in accordance with one embodiment;

FIG. 4 is a block diagram of an array of subimages and a completed high resolution photo of the original image in accordance with one embodiment;

FIG. 5 is an illustration showing an overlap of subimages in order to compensate for the tiling or stitching function in accordance with one embodiment;

FIG. 6 is a flow diagram of a process of creating a digital picture having a higher resolution than the maximum resolution capability of a digital camera in accordance with one embodiment;

FIG. 7 is an illustration showing another embodiment of the present invention in accordance with one embodiment;

FIG. 8A is an illustration showing an array of cells overlaying scene and a sample picture taken of one of the cells;

FIG. 8B is a similar illustration showing an array of cells and an example of another subimage being captured;

FIG. 9 is a diagram illustrating the stitching of subimage tiles corresponding to each cell in the array;

FIG. 10 is a flow diagram of a process of creating an extended FOV picture using a camera having an actuated mechanism for adjusting the position of the imager in accordance with one embodiment;

FIG. 11 is a diagram of a table showing data that may be used by the extended FOV module to determine the array of cells;

FIG. 12 is a logical block diagram showing relevant components and data structures in a digital camera capable of high-resolution and extended FOV images in accordance with one embodiment;

FIG. 13 is an illustration of the front of a camera showing an actuator mechanism and the various ways it can position an imager in accordance with one embodiment; and

FIGS. 14A and 14B are illustrations of a computing system suitable for implementing embodiments of the present invention.

### DETAILED DESCRIPTION OF THE INVENTION

Methods and systems for taking photographs using a digital camera having either a resolution that is higher than the normal resolution of the digital camera or having a field of view that is greater than the normal capability of the camera hardware are described in the various figures. Some of the described embodiments enable a digital camera having a fixed maximum resolution or maximum optical zoom level, to take multiple photos of different portions of a scene and create a larger photo of the same scene having a resolution that is higher than the fixed or native maximum or feasible resolution of the camera. In one embodiment, the term resolution is used to refer to the number of pixels per angle of FOV, i.e., the number of pixels rendered in a 1 degree by 1 degree view by the user, referred to as a solid angle. Other embodiments enable a digital camera having a fixed field of view (FOV), measured in horizontal and vertical angles, to take photos that have a wider horizontal and/or vertical FOV than the fixed FOV of the camera. These embodiments are enabled on a digital camera that maintains its compactness and consumer-friendly attributes, such as being hand-held, lightweight, and easy to use, integrated and fully automated with respect to image capture and final image creation.

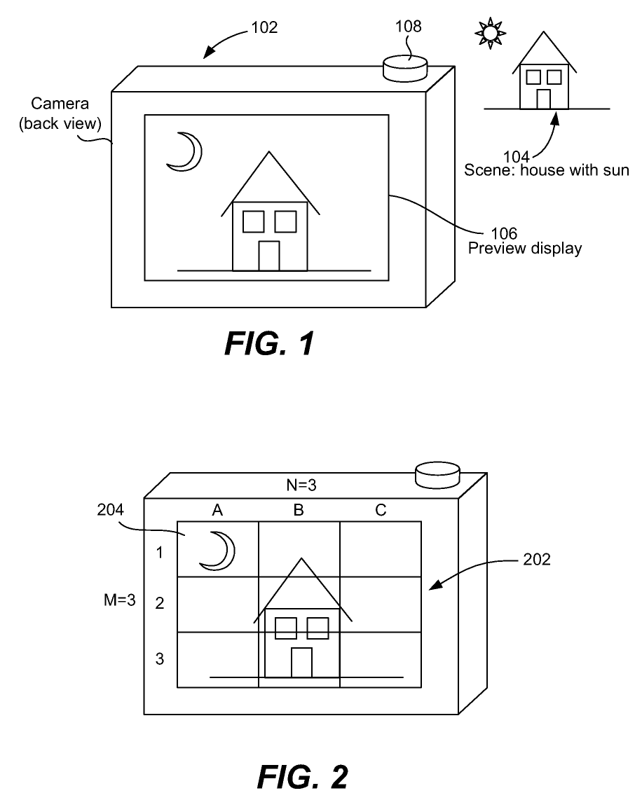

FIG. 1 is an illustration of an initial photo also referred to as image capture, using a digital camera. Shown are a digital camera 102 and a scene 104. It also shows a back view of camera 102 (lens, actuator, and other components on the front face of camera 102 are not shown in FIG. 1). Most digital cameras have a “preview” display, which also performs as a viewfinder (typically the display is an LCD screen). In FIG. 1, a preview display 106 shows scene 104. The user uses display 106 to find the scene or image that she wants to photograph or capture. Here scene 104 is a house with the sun in the background. In a typical case, camera 102 may use an autofocus feature to focus on the center of the image or an object in the center of the scene, in this case the house, adjust for lighting, and capture the image. One feature discussed below is the optical zoom level used to take the picture (hereafter, the term “zoom” is intended to represent “optical zoom,” unless otherwise noted). With some cameras, the zoom level or focal length is fixed and with other the user can “zoom in” or “zoom out” as desired, that is, the users can adjust the focal length. With digital cameras, zoom level is often presented to the user as 2×, 4×, 6× and so on, to more clearly present the options for zooming in or out. Every camera has a maximum optical zoom level, which is determined by the physical characteristics of the lens subsystem hardware. In FIG. 1, once the user takes a picture of scene 104 by pressing button (shutter release) 108, the image that is captured may be displayed on display 106 for a few seconds before returning to its function as a view finder.

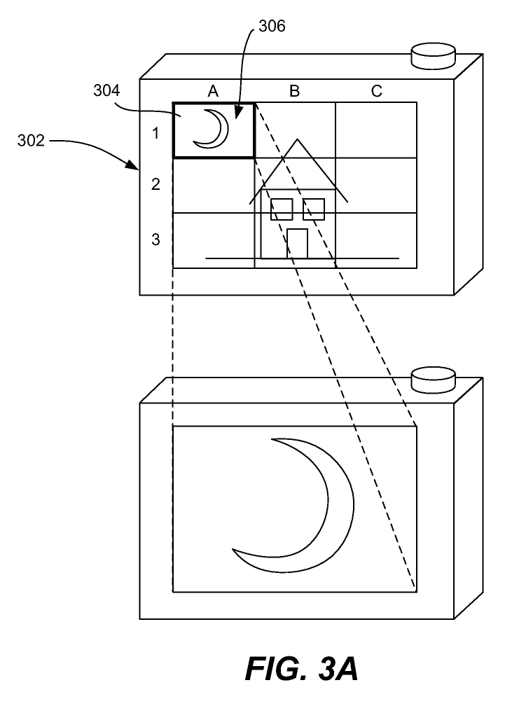

However, in one embodiment of the present invention, when the user presses button (shutter release) 108 once, rather than taking one image capture of scene 104 in its entirety (as would be done with a conventional film or digital camera) multiple photos or image captures are taken of different segments (tiles) of scene 104. FIG. 2 is a block diagram of digital camera 102 showing preview display 106 in accordance with one embodiment. Preview display 106 showing scene 104 has multiple vertical and horizontal lines forming a grid or array of cells (more generally, there may be one vertical and one horizontal line creating a grid of four cells). In the example shown, an array 202 has nine cells, a sample cell 204 shown in the top right corner of array 202. Vertical columns of cells are labeled A, B, and C and horizontal rows of cells are labeled 1, 2, and 3. These labels do no appear on preview display 106 or on the body of camera 102; they are shown for illustrative purposes. Processes for determining the dimension of array 202 are described in detail below. For example, an array may be 2 by 2 or 3 by 4. In another embodiment, the vertical and horizontal lines (without the labels) may be shown on preview display 106 (visible to the user). However, the visibility of array 202 to the user on display 106 is not necessary for the processes described for creating a high-resolution image of scene 104, but may be displayed for informational purposes or as an indication that the “high resolution” feature of the camera is in progress.

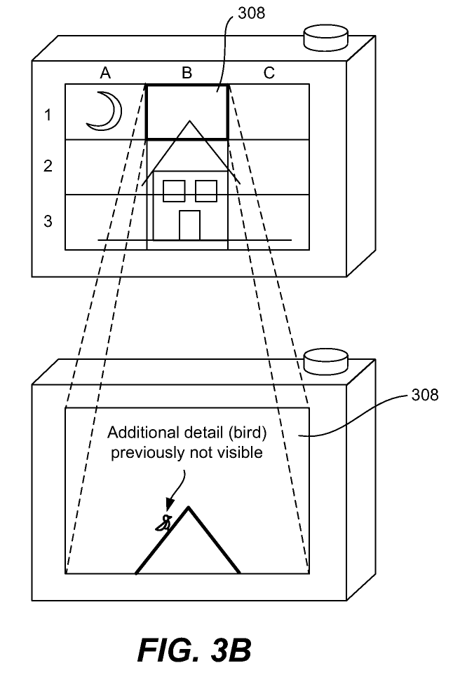

Each cell, such as cell 204, represents a single photo or image capture to be taken by the camera. In the described embodiment, when the user presses shutter release 108, the camera will take nine photos, one for each cell. Each photo taken is referred to herein as a subimage. The component of camera 102 that takes the subimage is referred to as an imager (not shown in FIGS. 1 and 2). The imager and other components, such as the actuator, the component that houses the imager, are described briefly. A detailed description of these components and other hardware characteristics of camera 102 are provided in pending patent application, entitled “System and Method For Automatic Image Capture In a Handheld Camera with a Multiple-Axis Actuating Mechansims”, filed Nov. 16, 2007, having Application Ser. No. 11/941,837, and “System and Method for Object Selection In a Handheld Image Capture Device,” filed Nov. 16, 2007, having application Ser. No. 11/941,828, both of which are incorporated by reference in their entirety and for all purposes. In one embodiment, the imager takes nine image captures in a certain order and automatically. The order or sequence of the image capture may vary. For example, the image may take pictures horizontally, for example, A1, B1, C1, C2, B2, A2, or vertically, A1, A2, A3, B3, B2, B1, . . . . As described below, the imager is physically moved and situated by an actuator mechanism to “point” in the direction of each of the cells in array 202. Each of the nine pictures is taken automatically while the user holds the camera and maintains the image of the scene in preview display 106. The expected range of times will not require users to utilize tripods or mounts to hold the camera. Processes for taking each subimage and creating a single high-resolution photo are described below. The image capturing process is illustrated further in FIGS. 3A and 3B.

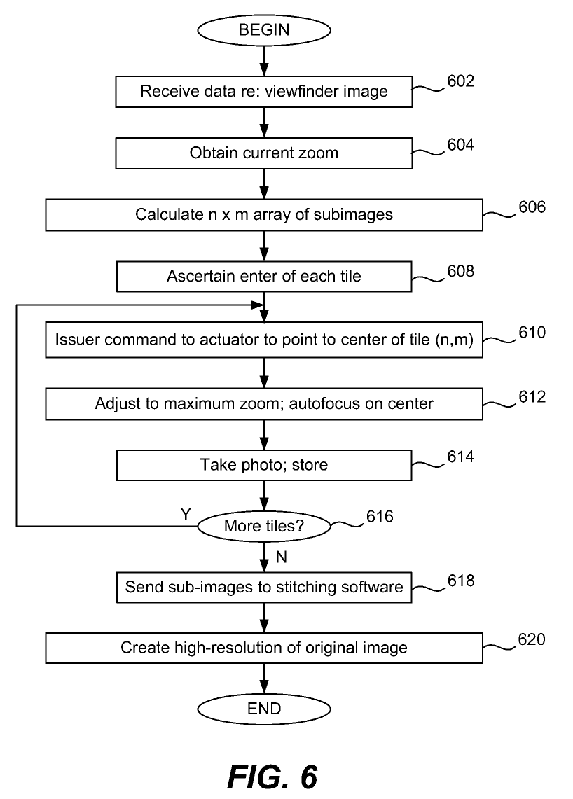

FIG. 3A is a logical block diagram showing two images displayed in preview display 106 during the process of taking a high-resolution photo of scene 104 and also shows a front view of camera 102 in accordance with one embodiment. Camera 102 showing display preview 106 with array 202 as shown in FIG. 2 is also shown in FIG. 3A. A detailed view of cell A1 is shown in a second rendition 302 of camera 102. In this example, cell A1 contains an image 304 of the sun. An actuated imager or lens 306 shown on the front of the camera pans (horizontal movement) and tilts (vertical movement) to the center of cell A1. More detailed figures showing the possible positions of the actuator mechanism containing the camera lens is shown in FIGS. 3A and 3B. The imager “zooms in” (applies maximum optical zoom or focal length) on the center of cell A1 after the actuator has positioned or actuated the lens for that cell. Once centered, the imager performs autofocusing functions on that cell, if this feature is available on the camera. It may also automatically adjust for lighting and other factors. As described in the flow diagram of FIG. 6, the camera performs other functions, such as storing the digital image. Subimage 304 from cell A1 will have a higher resolution of the scene (a picture of the sun) than the same scene shown in FIG. 2 in cell A1. Another example is shown in FIG. 3B. Here the actuator mechanism positions the lens, by panning and tilting, to center in on cell B1. The scene shown in cell B1 is of the top of the roof of the house. As this scene is shown in FIG. 2, the resolution shows only the general contours of the roof, but does not have sufficient resolution to show any details of the roof. The same scene shown in a subimage 308 taken after zooming on to the center of cell B1 and focusing on only the scene shown in the cell, more detail is visible because of the higher resolution. In this example, there is a bird on the roof of the house that can now be seen in subimage 308 that could not be seen in FIG. 2. The process continues with the actuator mechanism panning and tilting so that the lens or imager can capture a zoomed in and focused image of the next cell. Each of the captured subimages of each of the cells has a higher resolution of the same image or scene displayed in the array in FIG. 2.

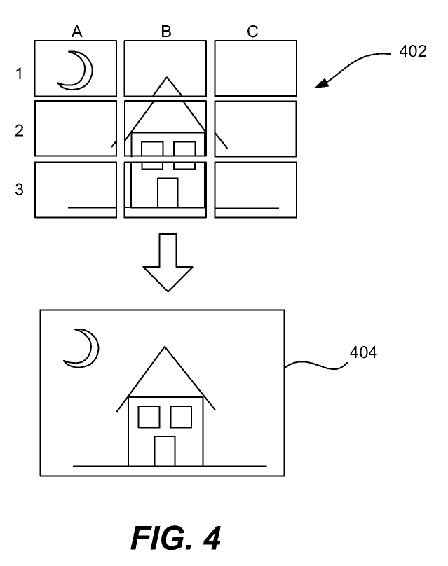

FIG. 4 is a block diagram of an array of subimages and a completed high resolution photo of the original image in accordance with one embodiment. An array of subimages 402 contains nine subimages as described above. Subimages 304 and 308 from FIGS. 3A and 3B are shown. As with subimages 304 and 308, each of the other subimages shown for each cell in array 402 is a high resolution subimage. The subimages are stitched together to compose a single high-resolution image. The single image has details that were not visible in the original image shown in FIG. 2, such as the bird on the roof in subimage 308. Each of the subimages was taken after having the actuator mechanism containing the imager pans and tilts to the correct position and the imager zooming in and focusing on the cell. The subimages are tiled or stitched together to compose a single picture 404.

Although slight movement of the user's hands may move the camera slightly between capture of subimages, the sensors and actuators in the actuated imager can together compensate for this movement, removing the need for external stabilization devices such as tripods.

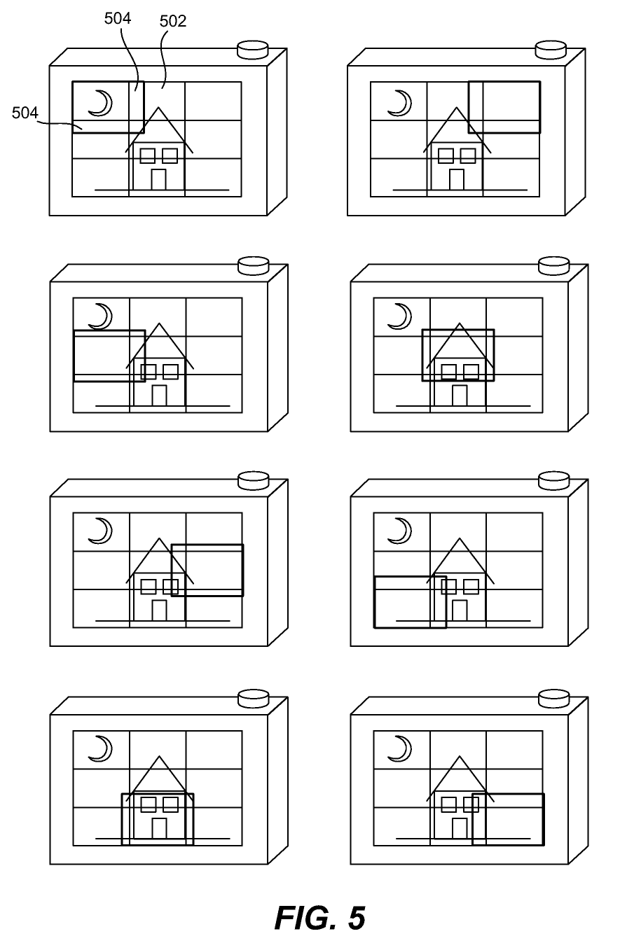

FIG. 5 is an illustration showing an overlap of subimages in order to compensate for the tiling or stitching function in accordance with one embodiment. Each subimage, such as subimage 502, captured by the imager is larger than the cell itself. This is shown by the areas outlined with the bold lines in each of the arrays shown in FIG. 5. The amount of overlap 504 into adjacent cells depends on the requirements of the stitching software used to stitch the subimages into a completed high-resolution image; for example, a particular stitching software may require a minimum of 15% overlap between adjacent subimages in order to produce reliable results. Thus, when the lens zooms in on the center of each subimage 502, the actual area of the subimage is shown by the boxes with the bold outlines. Stitching software is commercially available from EasyPano of Shanghai, China and executes on the digital camera. In other embodiments, the subimages may be downloaded onto a computer or computing device and may be processed by stitching software executing on the device. The actual area of each subimage is larger by a certain percentage, for example 10%, than each cell as shown in the arrays described above. As is required by most commercially available stitching software applications, overlap 504 is needed in order for adjacent subimages to be correctly and reliably aligned and merged together by the stitching software

FIG. 6 is a flow diagram of a process of creating a digital picture having a higher resolution than the maximum resolution capability of a digital camera in accordance with one embodiment. Before the process begins, the user frames the scene she wants to photograph so that the scene is displayed in the camera's preview display screen. Once the user is satisfied with the scene displayed and the camera settings, she presses the shutter release button. One of the settings or features selected by the user is that the camera create a high resolution photo of the scene being shot. This may be a menu item selected by the user or may be selected using a physical switch or button on the camera. At step 602 the camera software receives data on the image that was captured by the imager. This image may be used for reference and for internal use during subsequent processing. For this image the actuator has positioned the imager directly straight (0 degrees panning and tilting). For the purposes of illustration, the resolution of the image received at step 602 is referenced as x.

At step 604 the software for creating a high resolution picture obtains the current optical zoom level (focal length) of the camera, that is, the zoom level used for the image that was captured. This optical zoom level may have been selected by the user when framing the scene if the camera has this feature (i.e., a mechanism to allow the user to zoom in and zoom out) or may be automatically set by the camera software. In this example, the optical zoom level is x, and is provided to the high-resolution creating software. In one embodiment, at step 604 the software also obtains the maximum optical zoom level of the camera. This information may be constant and stored in the software. For purposes of illustration, we take the maximum zoom level as being 4× or four times the current zoom level. As described below, this maximum zoom level is used in one embodiment to calculate array dimensions and to ultimately determine the resolution of the final picture, which will be the maximum resolution attainable using the software. In another embodiment, the user may select the resolution of the final picture, which may be less than the maximum attainable resolution. For example, the user may want to conserve memory and may be satisfied with a picture that is not the maximum resolution possible by the software, but is still more detailed than the original picture. In this embodiment, instead of reading the maximum zoom level, the software reads the zoom level selected by the user (e.g., 2.5×).

At step 606 the software utilizes the maximum zoom level (or zoom level entered by the user) and the current zoom level and calculates the array dimensions, specifically the number of rows r and the number of columns c for the array and, thus, the number of cells. As described above, the number of cells will determine the number of subimage photos that will be taken by the imager to create the final photo. By using the maximum (or user-selected maximum) zoom level of the imager and the zoom used to display the preview image (conveyed by the data received at step 602) the software can calculate how many cells can or should be used to take subimage photos.

At step 608 the software calculates the coordinates or position of the center of each cell. In one embodiment, the center of each cell is determined using the overlap cell sizes as shown in FIG. 5. The centers of each overlap cell area may be calculated using coordinates with the original preview display image as the reference, with the center of the original preview image as 0 degrees horizontal and 0 degrees vertical. At step 610 an instruction is sent to the actuator mechanism to point the imager to the center of the first cell in the array to be photographed. By default, the first cell may be the top left corner cell or any other arbitrary fixed cell. As described in the incorporated patent application, the actuator may receive commands from software in the camera to position the lens to any position within the actuator's physical range by panning and tilting. At step 610 the actuator receives its first command to point at the center of a particular cell. Once the imager is pointed in the correct direction, at step 612 the imager is adjusted to the maximum zoom level at 4x or to the selected zoom level. Once at the target zoom level, the imager focuses on the scene using autofocus capability (if available), thereby producing a close-up of a segment of the original image. Examples of this image are shown in FIGS. 3A (of the moon and 3B (the roof of the house showing the bird).

At step 614 the camera takes a photo of the image created at step 612. This photo is taken using the normal operations of the camera, as if the user had pointed the camera at the subimage, maximized the zoom and taken the picture. The photo is stored in memory and may be tagged in some manner with the cell number or row and column numbers, to indicate that it is a subimage that will be input to stitching software along with other subimages, and to indicate its future placement relative to the other subimages.

At step 616 the software determines whether there are any remaining cells in the array that need to be processed. There are many ways the software can keep track of this, such as keeping two counters for the row number and column number of the current photo in the array of subimages, or keeping a single counter up to the total number of cells determined at step 606 and decrementing the counter after each subimage is captured. If there are more cells, control returns to step 610 where the actuator mechanism is sent another command to position the imager to point to the center of the next cell. Data relating to the center coordinates of each cell may be stored in RAM at step 608. The actuator re-positions and the process is repeated (steps 612 and 614). If it is determined that there are no more cells at step 616, control goes to step 618 where all the subimage photos that were stored at step 614 are inputted to stitching software resident on the camera.

User movement may be compensated using accelerometers and actuators, as described in the incorporated patent applications.

Stitching or photo tiling applications may accept input in various formats, but essentially they are given multiple photos (in the example above, it may receive nine subimage photos) and information on the arrangement of the photos. The stitching software may require that the subimages it receives already overlap with adjacent subimages as described above so that it may proceed to perform its operations. At step 620 the software receives the output of the stitching software and finalizes the creation of the high-resolution image of the original image. In the example used here, the entire high-resolution image is at a 4× zoom level of the original image. It has approximately four times the number of pixel horizontally and vertically, giving the final picture approximately 16 times the number of pixels in the preview display (the actual amount of pixels will be somewhat less depending on the amount of overlap between adjacent images that is required). Such an image could not be taken by the camera using normal optical zooming capabilities since the largest image that could be obtained at the 4× zoom level would be only as large as one of the subimages. The final high-resolution image created at step 620 contains approximately 16 times as much information (pixels) as is contained by a photo taken by the same camera at its maximum native resolution in its normal operation.

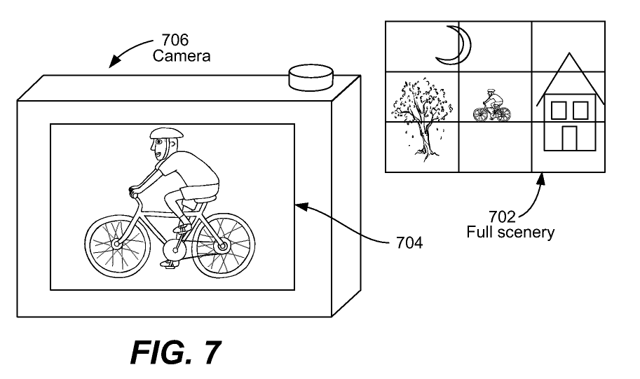

FIG. 7 is an illustration showing another embodiment of the present invention. A full scene 702 includes a tree, sun, house, and a person riding a bike. The scene covers a wider area and, for purposes of explaining the embodiment, is larger than what can be covered by the lens and imager of the camera. A preview display 704 on camera 706 displays only a portion of scene 702, the person riding the bike. However, the user would like to capture the entire scene 702, but because of limitations of a conventional camera, is unable to. In the described embodiment, a camera of the present invention is able to take a picture of the entire scene 702 by having an actuator position the imager to capture images of cells comprising the scene. This concept is similar to the embodiment described above with respect to high-resolution pictures. However, in this embodiment, the resolution of the final picture (as measured by pixels per solid angle, as noted above) is the same as the resolution of the initial image captures. The final picture captures a field-of-view (FOV) that is greater horizontally and vertically than what may be captured based on physical limitations of the camera lens (e.g., zooming capability) and of the pan/tilt range of the imager. In another embodiment, the FOV captured may only be greater horizontally, creating what is commonly referred to as a panoramic photo of a scene.

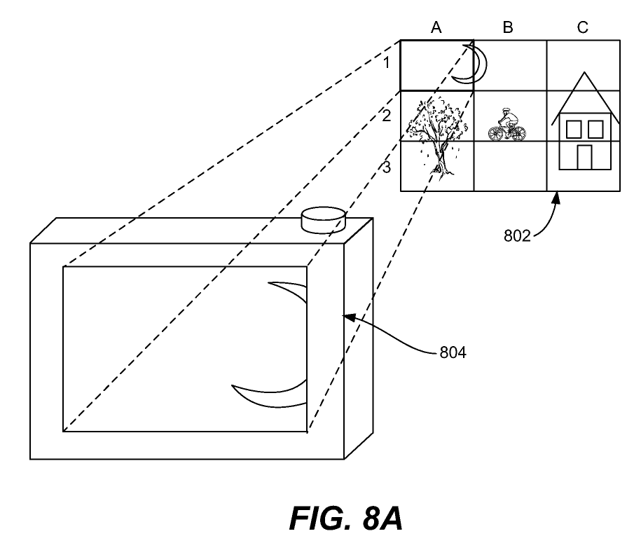

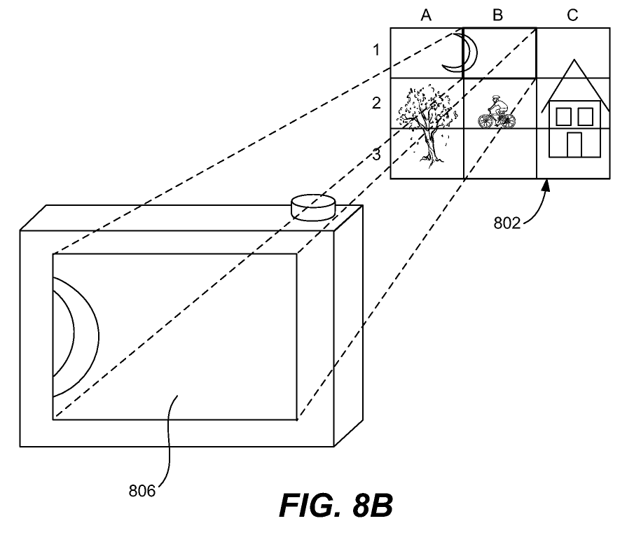

FIG. 8A is an illustration showing an array of cells overlaying scene 702 and a sample picture taken of one of the cells. As described above, a grid or array of cells 802 contains a certain number of columns and rows, in this example, three columns (A, B, C) and three rows, creating an array of nine cells. The computation of the array dimensions is described below, but generally, it may depend on factors such as the lens setting when the initial image is captured and the physical limitations of the actuator mechanism (i.e., how far can it pan to the left/right or tilt up/down). A subimage 804 taken in the example shown in FIG. 8A is a portion of the moon. To take this picture, the actuator mechanism may pan and tilt to its maximum capability, in one embodiment, to point the imager at the upper left corner of the scene. In the described embodiment, the lens takes the picture without changing zoom level (i.e., resolution) and stores it.

FIG. 8B is a similar illustration showing array of cells 802 and an example of another subimage 806 being captured. In this case, subimage 806 is the other half of the moon. This subimage 806 extends the vertical FOV of the initial preview image of the person riding a bike. In this manner, each subimage in array of cells 802 is captured, stored, and stitched together to comprise an extended FOV image of the original image.

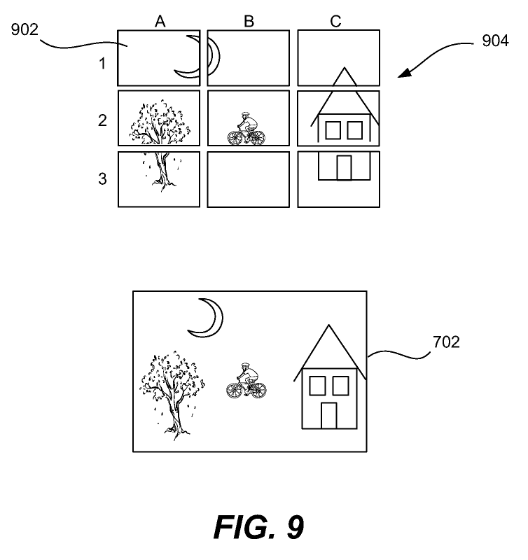

FIG. 9 is a diagram similar to FIG. 4 illustrating the stitching of subimage tiles corresponding to each cell in the array. As described above, each subimage, such as subimage 902, taken may be somewhat larger than the actual subimage shown in the cell. As noted, the actual subimage captured may be 10-25% larger than the subimage needed to comprise the final extended view photo in order to accommodate the overlap between adjacent subimages that is needed for most stitching software; this overlap is shown and conveyed in FIG. 5. The array of cells 904 is shown with each of the tiles separated and subimage 902 shown in each tile. In this example, there are nine tiles in a 3×3 array. There may be other array dimensions that can be used. In the embodiment where only the horizontal FOV is extended, the number of rows is one and the number of columns may vary. Once the multiple subimages are stitched, a final photo having an extended horizontal and vertical FOV shows full scene 702. That is, the images surrounding the person riding a bike, namely, the tree, moon, and house.

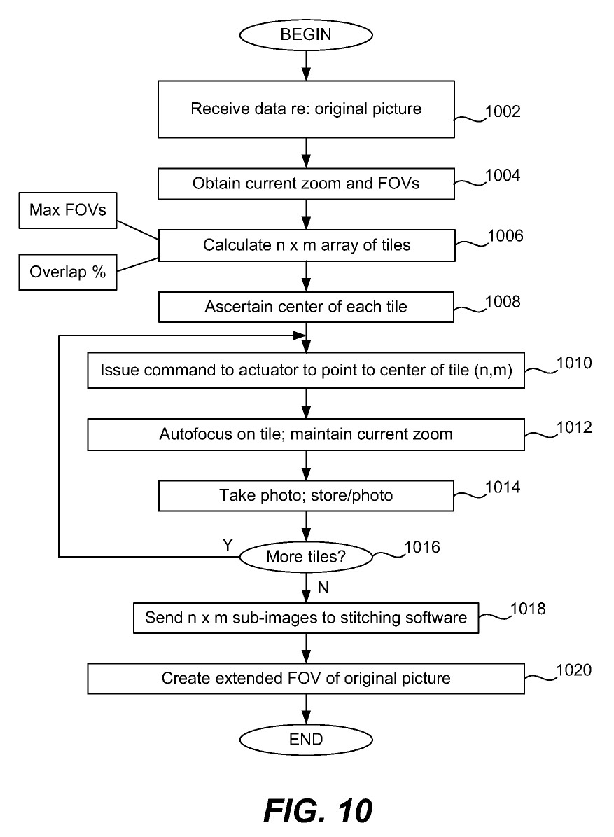

FIG. 10 is a flow diagram of a process of creating an extended FOV picture using a camera having an actuated mechanism for adjusting the position of the imager in accordance with one embodiment. Before the first step, the user has framed the center of the extended FOV photo that the user wants to take and has activated or enabled the extended FOV feature on the camera. As with the high-resolution embodiment, this may be a physical button or switch on the camera or may be enable via the camera menu, provided on nearly all digital cameras. Using the example above, the user may want to take a picture of entire scene 702 which has the bicyclist at an approximate center. Once the user has positioned the camera so that only the bike is shown in the preview display, she presses the shutter release button. At this moment, the actuator is pointing the imager directly ahead (for reference, this may be referred to as a 0 degree horizontal and a 0 degree vertical position).

At step 1002 the camera receives data on the first picture taken. This may be a subimage of the center of the extended FOV picture, leaving only eight more subimages to be captured in this illustration. In another embodiment, a subimage of the center may not be captured, postponing it until later in the process (i.e., after the array has been calculated). In this case, data on the center image is received by the camera and used in subsequent steps.

At step 1004 the extended FOV software in the camera obtains the current zoom levels set by the user when taking the extended FOV picture. This zoom level provides the current horizontal and vertical FOVs in terms of degrees. If the user has zoomed in so that the center of the image looks close and the user can see, through the preview display, more details on the bike, for example, the FOVs will be relatively small. If the user zooms out the current FOVs will be large relative to the “zoom-in” situation.

At step 1006 the software reads the current FOVs and calculates the dimensions of the array of cells (the number of rows and columns) as was done at step 606 of FIG. 6. In order to do this, in one embodiment, the software uses the maximum FOV angles (e.g., 120 degrees) and the overlap percentage needed by the stitching software. By using this data, the software may calculate the dimensions of the array. Methods of calculating these may be described by the following formulas:

c=HFOVₘₐₓ/(HFOV_{current}*(1−overlap))

r=VFOVₘₐₓ/(VFOV_{current}*(1−overlap))

where: HFOVₘₐₓ and VFOVₘₐₓ are the maximum FOV angles (horizontal and vertical, respectively), HFOV_{current} and VFOV_{current} are the current FOV angles (horizontal and vertical, respectively); overlap is the percent overlap between adjacent subimages, expressed as a decimal (so a 15% overlap is expressed as 0.15); and c and r are the resulting number of columns and rows, respectively.

At step 1008 the software ascertains the center of each tile. Once the array dimensions have been calculated at step 1006, the center coordinates can be calculated using multiples of the current FOVs. More specifically, the center of a tile n images to the right and m images up from the reference tile can be calculated by adding (n*HFOV_{current}) and (m*VFOV_{current}) to the coordinates for the center of the reference tile (this example ignores the overlap for simplicity).

At step 1010, the extended FOV software module issues a command to the actuator to point to the center of the first tile. In one embodiment, this may be the top left tile (or left-most tile). The actuator mechanism is provided with the coordinates of the center of the first tile and points the imager accordingly. At step 1012 the camera focuses automatically (if this feature is available on the camera) on the subimage framed within the tile, taking into account the stitching overlap. It is worth noting that the current zoom level of the camera is not changed. At step 1014 the camera takes a picture of the subimage and stores it. At step 1016 the software determines whether there are any more tiles or cells in the array that have not been processed. If there are, control returns to step 1010 where the software instructs the actuator to adjust so that the scene in the next tile is captured. The same steps are repeated until the number of remaining tiles is zero. If there are no tiles left at step 1010 control goes to step 1018 where the subimages are sent to the stitching module. The stitching program, as described above, compiles the subimages into a single photo using known techniques. At step 1020 the final extended FOV image is created by the camera. The image may be created by the stitching program and outputted to standard or conventional camera software; at this stage the extended FOV module may no longer be needed and the process is complete.

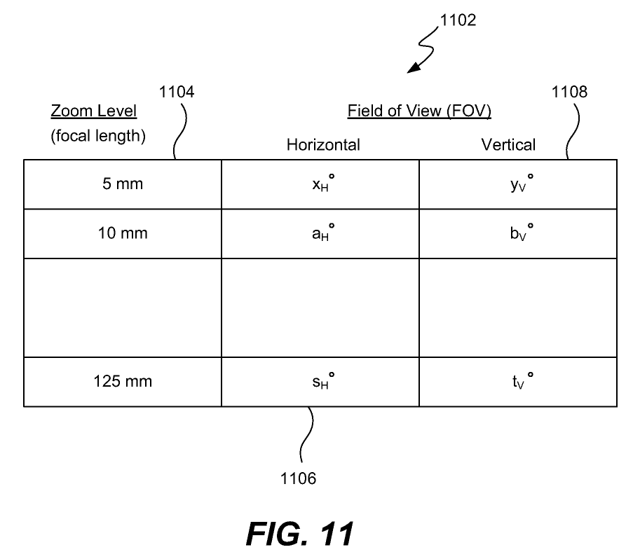

FIG. 11 is a diagram of table 1102 showing data that may be used by the extended FOV module at step 1006 to determine the array of cells. In one embodiment, table 1102 (or a data file) has three columns of data or data types including zoom level (focal length) 1104, horizontal FOV 1106, and vertical FOV 1108 (this data may also be organized and stored in a flat file or in a non-tabular form). Zoom levels and focal lengths vary widely depending on the type of camera, but focal lengths typically range from 30 to 200 mm. In one embodiment, each row in table 1102 corresponds to a zoom level setting, for example, in 5 mm increments, or in increments appropriate for the camera, which may not be spaced at equal increments (e.g., 5 mm, 13 mm, 18 mm, and so on until the maximum focal length). Each zoom level has a corresponding horizontal FOV degree and a vertical FOV degree. These values are used, in one embodiment, at step 1006 in the formulas provided. As noted, HFOV_{current} may be drawn from column 1106 and VFOV_{current} may be drawn from column 1108, based on the current zoom level. The extended FOV software module already has, as a constant value, the maximum angles HFOVₘₐₓ and VFOVₘₐₓ, both measured in degrees.

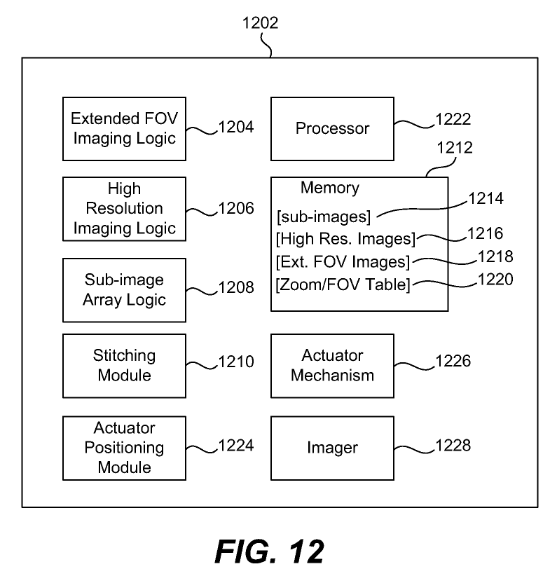

FIG. 12 is a logical block diagram showing relevant hardware components, logic modules, and data structures in a digital image capturing device, such as a digital camera, capable of high-resolution images and extended FOV images in accordance with one embodiment. A device 1202 has an imager logic module 1204 for processing extended FOV photos that may perform, among other functions, the processes described in FIG. 10. Device 1202 may also contain an imager logic module 1206 for processing high-resolution photos or images that may perform, among other functions, the processes described in FIG. 6. An array logic module 1208, which may be characterized as an array “calculator,” may be used to calculate the dimensions of the subimage array of cells as shown in FIGS. 4 and 9. In both cases (extended FOV and high resolution), and others (e.g., horizontal panoramic photos or combination high-resolution and extended FOV photos), camera operations may require the dimensions of the cell array, i.e., the number of rows and columns. Also shown is a subimage stitching application 1210 that accepts as input the subimages taken by imager logic modules 1204 and 1206.

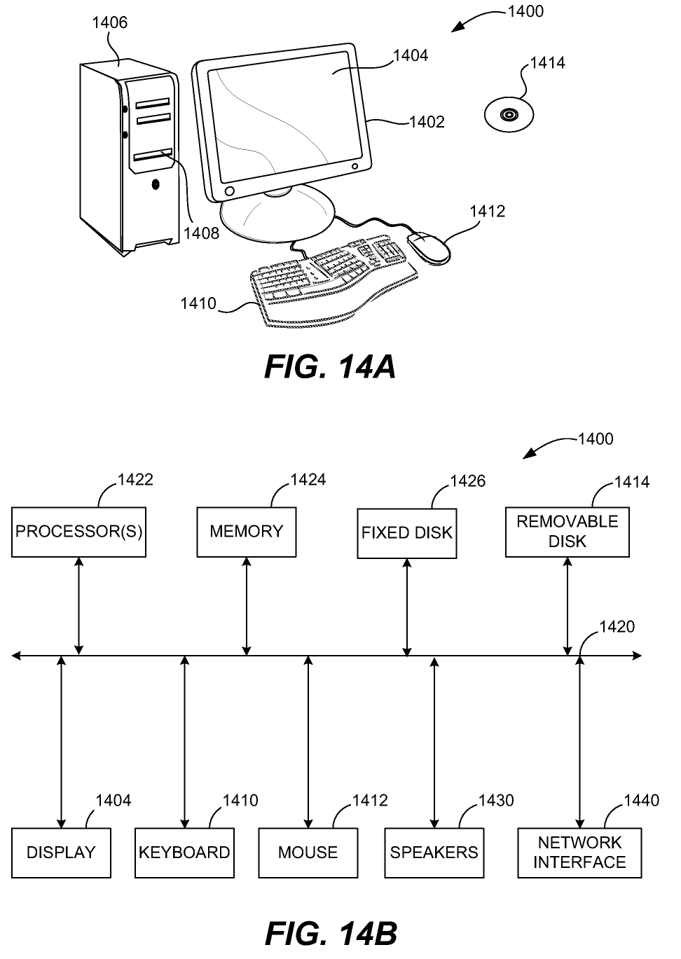

A memory 1212 stores various types of data, including subimages 1214 which include subimage photos taken in both processes (steps 614 and 1014). Also stored are the actual high-resolution resolution photos 1216 and the extended FOV photos 1218, along with other photos (not shown) taken by device 1202. Also stored is zoom level/FOV table 1220 described in FIG. 11. In other embodiments, different variations of this table may be stored and the format of the data may not be in the form of a table, for example, it may be in flat file. Device 1202 also includes a processor 1222, which executes the computing instructions stored on the device, including an actuator positioning logic module 1224, and an actuator mechanism 1226, described in the incorporated patent applications. The images are captured by an imager 1228 which may be a lens. A generic computing device is shown in FIGS. 14A and 14B where additional hardware components and data buses are described.

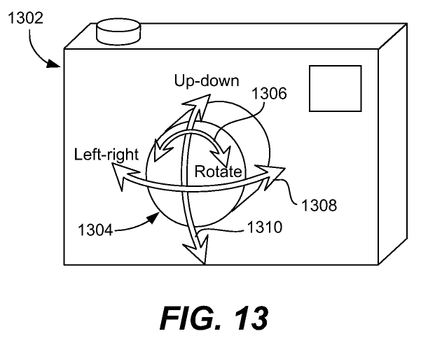

FIG. 13 is an illustration of the front of a camera showing an actuator mechanism and the various ways it can position an imager in accordance with one embodiment. A camera 1302 has an actuator mechanism 1304. Contained within the actuator is an imager or lens (not shown). Actuator 1304 can rotate in either direction as shown by arrow 1306. It can also pan left-right as shown by arrow 1308. This allows the imager to capture images on an extended horizontal FOV. Actuator 1304 can also tilt up-down as shown by arrow 1310 allowing the imager to capture images on an extended vertical FOV. As noted, details on actuator mechanism 1304 and the camera platform and hardware, their capabilities and implementations are described in the pending related applications and, thus, are not described any further in the present application.

FIGS. 14A and 14B illustrate a computing system 1400 suitable for implementing embodiments of the present invention. FIG. 14A shows one possible physical implementation of the computing system. Of course, the internal components of the computing system may have many physical forms including an integrated circuit, a printed circuit board, a digital camera, a small handheld device (such as a mobile telephone, handset or PDA), a personal computer or a server computer, a mobile computing device, an Internet appliance, and the like. In one embodiment, computing system 1400 includes a monitor 1402, a display 1404, a housing 1406, a disk drive 1408, a keyboard 1410 and a mouse 1412. Disk 1414 is a computer-readable medium used to transfer data to and from computer system 1400. Other computer-readable media may include USB memory devices and various types of memory chips, sticks, and cards.

FIG. 14B is an example of a block diagram for computing system 1400. Attached to system bus 1420 are a wide variety of subsystems. Processor(s) 1422 (also referred to as central processing units, or CPUs) are coupled to storage devices including memory 1424. Memory 1424 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 1426 is also coupled bi-directionally to CPU 1422; it provides additional data storage capacity and may also include any of the computer-readable media described below. Fixed disk 1426 may be used to store programs, data and the like and is typically a secondary storage medium (such as a hard disk) that is slower than primary storage. It will be appreciated that the information retained within fixed disk 1426, may, in appropriate cases, be incorporated in standard fashion as virtual memory in memory 1424. Removable disk 1414 may take the form of any of the computer-readable media described below.

CPU 1422 is also coupled to a variety of input/output devices such as display 1404, keyboard 1410, mouse 1412 and speakers 1430. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 1422 optionally may be coupled to another computer or telecommunications network using network interface 1440. With such a network interface, it is contemplated that the CPU might receive information from the network, or might output information to the network in the course of performing the above-described method steps. Furthermore, method embodiments of the present invention may execute solely upon CPU 1422 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are illustrative and not restrictive, and the invention is not to be limited to the details given herein, but may be modified within the scope and equivalents of the appended claims.

What is claimed is:

1. A method of creating a digital image, the method comprising:
obtaining a preview image having a first resolution;
obtaining a current zoom level;
calculating a subimage number;
performing subimage number of subimage captures, thereby creating an array of subimages; and
creating a second image based on the preview image, wherein the second image has a second resolution, and
wherein the second resolution is higher than the first resolution.

2. A method as recited in claim 1 wherein calculating a subimage number further comprises:
computing the product of a horizontal number of cells and a vertical number of cells from the array of subimages.

3. A method as recited in claim 2 wherein performing subimage number of subimage captures comprises:
obtaining a maximum zoom level of an image capture device.

4. A method as recited in claim 3 wherein the horizontal number of cells and the vertical number of cells are determined in part by the maximum zoom level.

5. A method as recited in claim 2 wherein a subimage corresponds to a cell.

6. A method as recited in claim 1 wherein creating a second image further comprises digitally combining a subimage from the array of subimages with at least one other adjacent subimage.

7. A method as recited in claim 1 wherein the current zoom level is a zoom level of the preview image.

8. A method as recited in claim 1 wherein performing multiple subimage captures further comprises focusing on the subimage.

9. A method as recited in claim 1 wherein the preview image has the same image area as the second image.

10. A method of creating a digital image, the method comprising:
obtaining a preview image having a first FOV including a first top border, a first bottom border, a first left border, and a first right border;
retrieving a current zoom level and the first FOV;
calculating a subimage number;
performing subimage number of subimage captures, thereby creating an array of subimages; and
creating a second image having a second FOV including a second top border, a second bottom border, a second left border, and a second right border,
wherein the second FOV is more expansive than the first FOV, such that a second image area is larger than a preview image area.

11. A method as recited in claim 10 wherein performing multiple subimages further comprises focusing on the subimage while maintaining the current zoom level.

12. A method as recited in claim 10 wherein the preview image and the second image have the same resolution.

13. A method as recited in claim 10 wherein calculating a subimage number further comprises calculating the product of a horizontal number of cells and a vertical number of cells from the array of subimages.

14. A method as recited in claim 10 wherein the horizontal number of cells is determined in part by panning capabilities of an actuator mechanism of an image capturing device.

15. A method as recited in claim 14 wherein the vertical number of cells is determined in part by tilting capabilities of the actuator mechanism of the image capturing device.

16. A method as recited in claim 10 wherein the first FOV has a first horizontal component and a first vertical component and the second FOV has a second horizontal component and a second vertical component and wherein the second horizontal component is greater than the first horizontal component and the second vertical component is the same as the first vertical component.

17. A method as recited in claim 10 wherein creating a second image further comprises digitally combining a subimage from the array of subimages with at least one other subimage.

18. A method as recited in claim 10 wherein calculating a subimage number further comprises examining zoom level and FOV data.

19. A method as recited in claim 10 wherein the first FOV has a first horizontal component and a first vertical component and the second FOV has a second horizontal component and a second vertical component and wherein the second horizontal component is greater than the first horizontal component and the second vertical component is greater than the first vertical component.

20. A digital image capturing device comprising:
a processor;
an imager;
an imager actuator mechanism;
an extended field-of-view (FOV) image creation module; and
a memory for storing
a plurality of subimages; and
a zoom level-FOV data file,
wherein the imager is positioned by the imager actuator mechanism based in part on data in the zoom level-FOV data file and wherein the imager captures the plurality of subimages from which a final extended FOV image is created.

21. A digital image capturing device as recited in claim 20 further comprising a subimage array logic component for calculating subimage array dimensions and which accepts as input at least a maximum FOV value of the device.

22. A digital image capturing device as recited in claim 20 further comprising a subimage stitching module for combining a first subimage with a second subimage from the plurality of subimages.

23. A digital image capturing device as recited in claim 20 further comprising an actuator positioning module for positioning the image actuator mechanism.

24. A digital image capturing device as recited in claim 21 wherein the image actuator mechanism has a maximum tilting capability and a maximum panning capability and wherein the subimage array dimensions depend in part on said maximum tilting capability and on the said maximum panning capability.

25. A digital image capturing device as recited in claim 20 wherein the zoom level-FOV data file further comprises a plurality of records wherein a record includes a focal length value, a corresponding horizontal FOV and a corresponding vertical FOV.

26. A digital image capturing device comprising:
a processor;
an imager;
an imager actuator mechanism;
a high-resolution image creation module; and
a memory for storing a plurality of subimages,
wherein the imager is positioned by the imager actuator mechanism based in part on a maximum optical zoom level value of the device and a current optical zoom level value and wherein the imager captures the plurality of subimages from which a final high-resolution image is created.

27. A digital image capturing device as recited in claim 26 further comprising a subimage array logic component for calculating subimage array dimensions and which accepts as input at least the maximum optical zoom level value of the device.

28. A digital image capturing device as recited in claim 26 further comprising a subimage stitching module for combining a first subimage with a second subimage from the plurality of subimages.

29. A digital image capturing device as recited in claim 26 further comprising an actuator positioning module for positioning the image actuator mechanism.

30. An apparatus for creating a digital image, the apparatus comprising:
a preview image retrieving component, the preview image having a first resolution;
a current zoom level detection component;
means for calculating a subimage number;
means for performing subimage number of subimage captures, thereby creating an array of subimages; and
means for creating a second image based on the preview image, wherein the second image has a second resolution,
wherein the second resolution is higher than the first resolution.

31. An apparatus as recited in claim 30 further comprising a means for computing the product of a horizontal number of cells and a vertical number of cells from the array of subimages.

32. An apparatus as recited in claim 30 wherein the means for creating a second image further comprises a means for digitally combining a subimage from the array of subimages with at least one other adjacent subimage.

33. An apparatus as recited in claim 30 further comprising a means for focusing on the subimage.

34. A computer-readable medium storing computer instructions for creating a digital image using a digital image capture device, the computer-readable medium comprising:
computer code for obtaining a preview image having a first FOV including a first top border, a first bottom border, a first left border, and a first right border;
computer code for retrieving a current zoom level and the first FOV;
computer code for calculating a subimage number;
computer code for performing subimage number of subimage captures, thereby creating an array of subimages; and
computer code for creating a second image having a second FOV including a second top border, a second bottom border, a second left border, and a second right border,
wherein the second FOV is more expansive than the first FOV, such that a second image area is larger than a preview image area.

35. An apparatus for creating a digital image, the apparatus comprising:
a preview image retrieving component, the preview image having a first FOV including a first top border, a first bottom border, a first left border, and a first right border;
a current zoom level detection component for detecting the current zoom level and determining the first FOV;
means for calculating a subimage number;
means for performing subimage number of subimage captures, thereby creating an array of subimages; and
means for creating a second image having a second FOV including a second top border, a second bottom border, a second left border, and a second right border,
wherein the second FOV is more expansive than the first FOV, such that a second image area is larger than a preview image area.

36. An apparatus as recited in claim 35 further comprising a means for calculating the product of a horizontal number of cells and a vertical number of cells from the array of subimages.

37. An apparatus as recited in claim 35 wherein the means for creating a second image further comprises a means for digitally combining a subimage from the array of subimages with at least one other subimage.

38. A computer-readable medium storing computer instructions for creating a digital image using a digital image capture device, the computer-readable medium comprising:
computer code for obtaining a preview image having a first resolution;
computer code for retrieving a current zoom level;
computer code for calculating a subimage number;
computer code for performing subimage number of subimage captures, thereby creating an array of subimages; and
computer code for creating a second image based on the preview image, wherein the second image has a second resolution,
wherein the second resolution is higher than the first resolution.
